(19) United States
(12) Patent Application Publication
(10) Pub. No.: US 2003/0003239 A1
(43) Pub. Date: Jan. 2, 2003

(54) Gasket applied texture coat for golf shafts

(76) Inventor: Charles L. Grubbs, Escondido, CA (US)

Correspondence Address: MURPHEY & MURPHEY, A.P.C., 701 PALOMAR AIRPORT DRIVE, SUITE 260, CARLSBAD, CA, 92009, US

(21) Appl. No.: 09/895,659

(22) Filed: Jun. 29, 2001

(51) Int. Cl. B05D 1/18; B05D 3/12

(52) U.S. Cl. 427/430.1; 427/355; 427/434.7

(57) ABSTRACT

A method of coating the shaft of a golf club with a smooth layer of curable wear-resistant liquid material, said material loaded with a high density of extremely small, hard-wearing particles, by the steps of providing an open-top, leak-proof container having a broad, wide base and at least one upstanding end wall, providing a first aperture in the upstanding container end wall, the aperture being of a size and shape sufficiently large to allow passing therethrough of the shaft of a golf club, the first aperture further defined by an inside-container side and an opposite, outside-container side, attaching a gasket over the first aperture, the gasket having a second aperture formed therethrough and aligning the second aperture with the first aperture so that the second aperture is located near the center of the first aperture, placing a volume of liquid coating material in sufficient volume to cover said container base, the material loaded with a high density of extremely small, hard-wearing particles, tilting the container slightly to one side so that the level of liquid volume drops below the first aperture and gasket and then inserting one end of the golf shaft to be coated into the aligned first and second apertures, tilting the container slightly to the other side so that the level of liquid material on the side of the container adjacent the gasket becomes great enough to cover the portion of the golf shaft inserted in the first aperture and gasket, and passing the golf shaft completely through the liquid and the first aperture and gasket to form the coating on the golf shaft.

### BACKGROUND OF THE INVENTION

1. Field of the Invention

This invention pertains to the field of sport accessories. More particularly, it pertains to the golf club industry and to a method of applying a unique, long-wearing finish to a golf club shaft and to the remarkable golf club produced thereby.

2. Description of the Prior Art

In the sport of golf it is almost as important to have top quality golf clubs and use top quality golf balls as it is to be competent in hitting and putting the ball. Golf is a pastime where friends meet, business associates conduct business, and athletes and non-athletes attempt to play a round and not have to hit the ball any more often than the experts require, or in other words, not to exceed par. With the social aspects held as important as the athletic aspects, the game emphasizes dress and golf equipment as being as important as ability.

In addition to looking good while playing golf, one needs to insure that his or her golf equipment does not fall below a generally accepted level of quality. Clearly, no one wants to play a round of golf in the company of another golfer whose equipment is scarred, dirty, covered with mud, or otherwise in shabby shape. One distinct area of potential damage to golf clubs is in the situation when they are withdrawn from the golf bag and/or inserted. therein.

During this activity, the club shafts rub against each other, against the club head, and against the inside of the golf bag. In all cases, the shiny finish on the club shaft is subject to a rubbing action against these hard surfaces. This rubbing action causes blemishes to the shafts and in severe cases scarring that can render the club unsightly and lower the esteem of the golfer. This problem can be cured by placing a textured coating of a very small particle, hardwearing material on the shaft that is hard and long wearing. This way, the damage caused to the club shaft by the activities of withdrawing and replacing the golf club in the bag is greatly ameliorated.

Prior art practices in placing such a coat of material on a club shaft has been limited to spraying the finish on the shaft. This is usually accomplished by turning the shaft while the spray gun is coating the shaft with the finish. However, this process is so expensive and fraught with difficulties that it is rarely used. Spraying the finish provides a coating process that is only 25% effective and the other 75% of the finish is lost to the surrounding air and surfaces. In addition, the finish often runs down the shaft during the coating operation causing highlights on the finished club shaft that are unacceptable to the purchasing public. To prevent runs, the painter often places only a very thin coating on the shaft which causes bald areas and areas where the finish is so thin that it crumbles during the first handling of the finished club.

There has been another coating system used, called the “gasket-coating” system but it has been used only with smooth coatings and was not thought usable with a coating system containing small discrete particles of hard wearing material. However, using the formulations of coatings available in this invention, the gasket-coating system produces a smooth, full coating of wear-resistant material on the shaft with no bald spots and no runs as occurs with the other coating systems.

### SUMMARY OF THE INVENTION

This invention is a method of coating the shaft of a golf club with a smooth layer of curable, wear-resistant liquid material wherein the material is loaded with a high density of extremely small, hard-wearing particles, on the order of 18 to 40 microns in size. The method is accomplished by the steps providing an open-top container, providing a first aperture in an upstanding end wall of the container, inserting an apertured gasket in the first aperture, placing a volume of the liquid coating material in the container, inserting one end of the golf shaft into the apertured gasket, tilting the container slightly to one side so that the depth of the liquid material adjacent the gasket becomes great enough to cover the portion of the golf shaft, and, simultaneously drawing the golf shaft completely through the liquid and the apertured gasket to form the coating on the golf shaft. The method is quick and easy to accomplish and it produces a beautiful, smooth coating of the hard-wearing material over the entire club shaft that will continue to look new and shiny no matter how the shaft is later treated.

Accordingly, the main object of this invention is a treatment for a golf club shaft that produces a good looking, long wearing finish that maintains the golf club in prize condition over a long term despite being withdrawn and inserted with other golf clubs in a golf bag or other carrier. Other objects of the invention include a simple method of coating a golf club shaft wherein virtually all of the coating material is used only on the shaft and none is lost to the surroundings as happens with sprayed finishes; a method of coating a golf club wherein the capital investment in such a method is limited to the procuring of a single coating container with a gasket; a method that provides a finish to a golf club without drips or runs that are common with prior art methods of coating; and, a method that does not require significant abilities so as to reduce production costs and lower the cost of the finished article.

These and other objects of the invention will become more clear when one reads the following specification, taken together with the drawings that are attached hereto. The scope of protection sought by the inventors may be gleaned from a fair reading of the claims that conclude this specification.

### DESCRIPTION OF THE DRAWINGS

FIG. 1 is a prospective view of the open-top container used in the preferred embodiment of the invention;

FIG. 2 is a close-up, sectional view of the container shown in FIG. 1;

FIG. 3 is a sectional side elevational view, taken along lines 3/4 in FIG. 2, of the container showing a portion of the golf shaft introduced into the aperture in the elastomeric membrane in the front end of the container; and,

FIG. 4 is same side elevational view, taken along lines 3/4 in FIG. 2, of the container as in FIG. 3 showing the container tilted to pool the coating liquid against the elastomeric membrane so that, as the shaft is drawn through the aperture, the shaft is coated with the pooled liquid.

### DESCRIPTION OF THE PREFERRED EMBODIMENT

Turning now to the drawings wherein elements are identified by numbers and like elements are identified by like numbers throughout the four figures, the method of this invention is shown in FIGS. 1 through 7.

As shown in FIG. 1, the first step in the method comprises providing an open-top elongated container 1 having a base 3, in this case a semi-round base, including side walls 4, a front container wall 5 and an upstanding rear end wall 7, said base 3 and walls 4, 5 and 7 interconnected along the length of their respective joints to form a leak-proof container cavity 9 capable of holding a volume 13 of liquid therein. Rear end wall 7 has a dip or cut-out 15 formed therein as shown. Container 1 can be made from virtually any material that will hold such a liquid without failure and common aluminum pipe and flat aluminum plate is preferred.

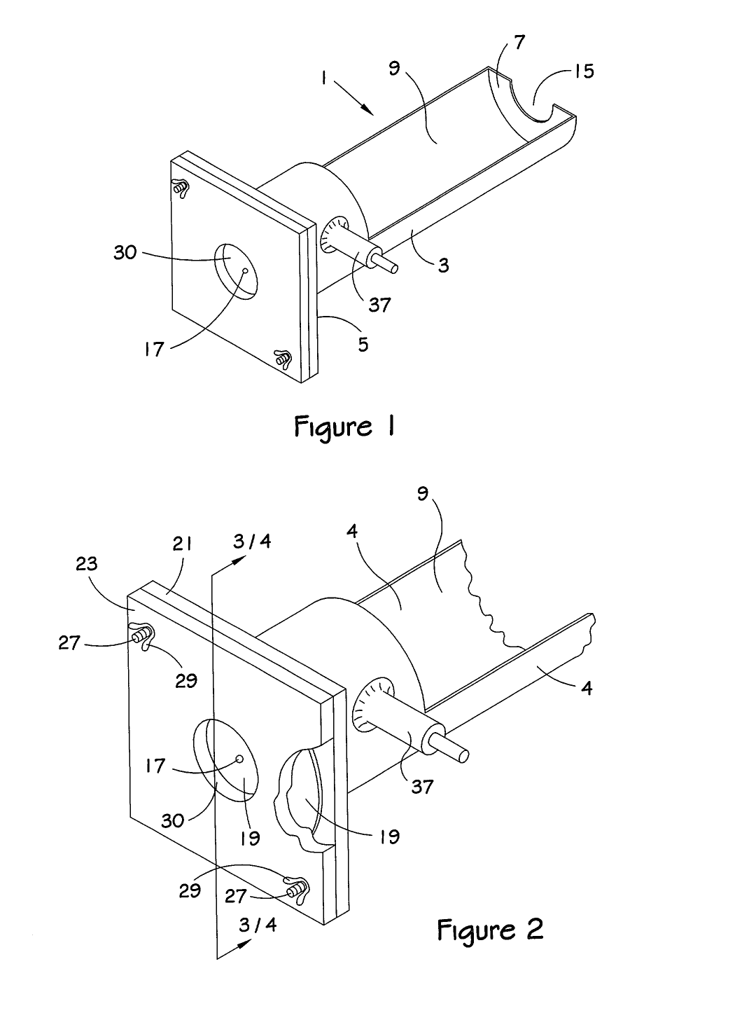

As shown in FIGS. 1 and 2, the next step in the inventive method comprises providing a flexible aperture 17 in upstanding front container end wall 5. Aperture 17 is preferably formed in a sheet of elastomeric material 19, such as rubber, Neoprene®, and or other such compounds held tightly between two end plates 21 and 25 respectively by threaded shafts 27 attached to plate 21 and extending outward through apertures formed in plate 23 and capped by wing nuts 29. Aperture 17 is held centrally in a large opening 30 formed through plates 21 and 25. Aperture 17 should be of a size smaller than the length of a golf club shaft 31 so that it must expand slightly when club shaft 31 is passed therethrough to avoid spillage of the liquid in volume 13. Shaft 31 is usually cylindrical, straight and long and made of fiberglass reinforced epoxy resins, graphite reinforced epoxy resins, steel and the like. Shaft 31 may increase in outside diameter, from one point on the shaft to another, and, in that case, first aperture 17 should be of a size and shape sufficiently large to allow passing therethrough of the largest diameter of shaft 31.

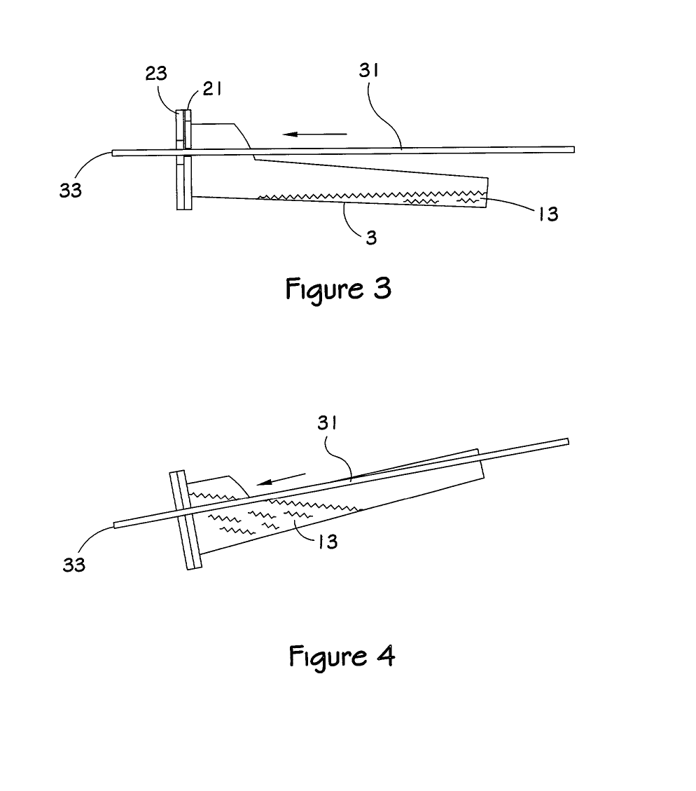

As shown in FIGS. 3 and 4, the next step in this method comprises placing a volume 13 of the liquid coating material in container 1 in sufficient volume to cover container base 3. The coating material useful herein is what is known in the coating industry as a 1-pack epoxy, a 2-pack epoxy, and a 2-pack urethane acrylic and/or polyester coating mix. Also found useful herein is a 1 and 2-pack thermoset plastic (system) and various other high performance resin systems. Each of the materials useful herein are loaded, either when received from the manufacturer, or immediately prior to use, with a density, such as 5 to 12 percent by weight, of extremely small, hard-wearing particles, such as polyurethylene particles 18-40 microns in diameter.

Also as shown in FIGS. 3 and 4, the next step in this method comprises tilting container 1 such that the level of liquid volume 13 drops below aperture 17 and then inserting one end 33 of golf shaft 31 into aperture 17, preferably from inside cavity 9, and passing shaft 31 through aperture 17 to the outside of container 1. In addition, shaft 31 is lowered until that part remaining above base 3 enters cut-out 15 to bring shaft 31 closer into parallel arrangement with base 3. When shaft 31 is of a varying diameter throughout its length, it is preferred that the smallest diameter end be inserted into first aperture 17 first and the largest end allowed to pass through aperture 17 last.

As shown in FIG. 4, container 1 is then tilted about a pair of mutually outwardly extending side arms 37 on each side of base 1 so that the level of liquid volume 13 moves toward the front end of container 1 and covers shaft 31 while it is inserted into aperture 17. In this configuration, golf shaft 31 is then slowly passed through aperture 17, from inside container 1 and under the surface of volume 13 of liquid in cavity 9 to the outside, so that it is coated with the thin, continuous film of curable liquid resin and the excess wiped off by the elastomeric nature of material 19. Side arms are placed equidistant from front wall 21 so that container 1 will pivot thereabout along a plane that bisects base 1. Shaft 31 is then allowed to stand at room temperature to allow the coating to cure into a hardened material. In some cases, the shaft may be subject to an oven treatment to force the coating to cure into a hardened material.

While the invention has been described with reference to a particular embodiment thereof, those skilled in the art will be able to make various modifications to the described embodiment of the invention without departing from the true spirit and scope thereof. It is intended that all combinations of elements and steps which perform substantially the same function in substantially the same way to achieve substantially the same result are within the scope of this invention.

What is claimed is:

1. A method of coating the shaft of a golf club with a smooth layer of curable wear-resistant liquid material by the steps of:
a) providing an open-top elongated container including a base, a front container wall and an upstanding rear container wall, said base and said walls interconnected along the length of their respective joints to form a leak-proof container cavity capable of holding a volume of liquid therein;
b) providing a flexible aperture in said front container wall, said aperture being of a size and shape sufficiently large to allow, with some flexibility, passing therethrough of the shaft of a golf club;
c) placing a volume of liquid coating material into said container, said coating material loaded with extremely small, hard-wearing particles, in sufficient volume to cover said container base;
d) tilting said container slightly from the horizontal so that the level of said liquid volume drops below said flexible aperture;
e) inserting one end of a golf shaft to be coated with said liquid into said aperture and lowering the shaft into close parallel configuration with said container;
f) tilting the container slightly in the opposite direction so that the level of said liquid material flows toward said front end wall and covers a portion of the golf shaft inserted in said aperture; and,
g) passing the golf shaft completely through the liquid and the aperture to form the coating on the golf shaft.

2. The method of coating the shaft of a golf club of claim 1 wherein said base is rounded on the bottom and sides thereof.

3. The method of coating the shaft of a golf club of claim 1 wherein said rear end wall has a dip or cut-out formed therein to allow the golf shaft, when inserted in said aperture, to be brought into closer parallel configuration with said container.

4. The method of coating the shaft of a golf club of claim 1 wherein said container is made from aluminum.

5. The method of coating the shaft of a golf club of claim 1 wherein said flexible aperture in said front container wall is part of a sheet of flexible material held between at least two plates in side-by-side orientation that together form said front container wall, said two plates held together with mechanical faster means.

6. The method of coating the shaft of a golf club of claim 1 wherein said flexible aperture in said front container wall is mounted centrally in a larger aperture formed in said front container wall.

7. The method of coating the shaft of a golf club of claim 1 wherein said flexible aperture is of a size and shape to allow passage therethrough of the smallest and the largest diameter portions of the golf shaft to be coated.

8. The method of coating the shaft of a golf club of claim 1 wherein said liquid coating material into said container contains from about 5 to about 12 percent by weight of small polyurethane particles.

9 The method of coating the shaft of a golf club of claim 8 wherein said small polyurethane particles are between about 18 to about 40 microns in diameter.

10. The method of coating the shaft of a golf club of claim 1 wherein the step of tilting said container slightly from the horizontal so that the level of said liquid volume drops below said flexible aperture involves pivoting said container about a pair of side arms extending mutually outward from each side of said container at locations equal in distance from said front wall of said container.

11. The method of coating the shaft of a golf club of claim 3 wherein the step of inserting one end of a golf shaft to be coated with said liquid into said aperture and lowering the shaft into close parallel configuration with said container includes the step of lowering the shaft into said cut-out in said rear wall to bring the shaft into closer parallelism with said container.

12. The method of coating the shaft of a golf club of claim 1 wherein the step of inserting one end of the golf shaft to be coated into said first aperture is accomplished from inside said container to the outside thereof.
